(19) United States
(12) Patent Application Publication
(10) Pub. No.: US 2016/0098525 A1
(43) Pub. Date: Apr. 7, 2016

(54) SYSTEM AND METHOD FOR REAL TIME INTEGRATION WITH HEALTH CARE APPOINTMENT MANAGEMENT SYSTEMS

(71) Applicant: DocASAP, Inc., Broadlands, VA (US)

(72) Inventors: Puneet Maheshwari, Broadlands, VA (US); Archana Gupta, Broadlands, VA (US)

(21) Appl. No.: 14/873,679

(22) Filed: Oct. 2, 2015

Related U.S. Application Data
(60) Provisional application No. 62/058,853, filed on Oct. 2, 2014.

(51) Int. Cl. G06F 19/00

(52) U.S. Cl. CPC G06F 19/327

(57) ABSTRACT

A health care appointment management system is provided. The health care appointment management system includes an integration module communicatively coupled to one or more electronic practice management systems (EPMs) of one or more health care providers. The integration module is configured to receive appointment scheduling data and appointment scheduling rules corresponding to the one or more health care providers. The health care appointment management system also includes a database configured to store the appointment scheduling data and the appointment scheduling rules corresponding to the one or more health care providers. In addition, the health care appointment management system includes a processing module configured to process the appointment scheduling data and to manage appointment updates for each of the one or more health care providers in accordance with the appointment scheduling rules of the respective health care provider.

### CLAIM OF PRIORITY

This application claims priority to U.S. Provisional Application No. 62/058,853, filed Oct. 2, 2014, and entitled “Real Time Healthcare Appointment Management System and Method,” the disclosure of which is incorporated by reference herein for all purposes.

### BACKGROUND

The invention relates generally to a health care appointment management system, and more particularly, to a method for real-time integration with health care appointment management system and/or electronic practice management (EPM) systems of health care providers.

Several online appointment scheduling systems exist to schedule appointments with a health care provider, for example with a medical practitioner, a physician, a radiologist and the like. For scheduling an appointment, these systems integrate appointments added to a calendar using multiple offline and/or online communication devices and provide such integrated information to a user for scheduling an appointment.

However, such appointment scheduling systems do not provide real-time schedule information for managing the appointments with the health care providers. The existing appointment scheduling systems utilize communication between operations representatives of the health care providers and end clients and/or users, which allows the representatives to manually collect availability information and then publish such information online. Moreover, for any new appointment booked through the system, the representatives have to work with the end client to insert the appointment in the client's system.

Thus, there is a need for a system that provides a unified real-time view of a health care provider's availability online. In particular, there is a need for an online appointment scheduling system that can integrate with disparate EPM systems of the health care providers to maintain data regarding the availability, booked times and most importantly the scheduling protocols of the practitioners of the health care providers.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

According to some examples of the present disclosure, a health care appointment management system is provided. The health care appointment management system includes an integration module communicatively coupled to one or more electronic practice management systems (EPMs) of one or more health care providers. The integration module is configured to receive appointment scheduling data and appointment scheduling rules corresponding to the one or more health care providers. The health care appointment management system also includes a database configured to store the appointment scheduling data and the appointment scheduling rules corresponding to the one or more health care providers. In addition, the health care appointment management system includes a processing module configured to process the appointment scheduling data and to manage appointment updates for each of the one or more health care providers in accordance with the appointment scheduling rules of the respective health care provider.

According to additional examples of the present disclosure, a computer-implemented method for managing health care appointments is provided. The method includes receiving appointment scheduling data and appointment scheduling rules corresponding to the one or more health care providers. The method also includes storing the appointment scheduling data and the appointment scheduling rules corresponding to the one or more health care providers. Moreover, the method includes processing the appointment scheduling data and managing appointment updates for each of the one or more health care providers in accordance with the appointment scheduling rules of the respective health care provider.

According to still further examples of the present disclosure, non-transitory computer readable mediums are described. Some example non-transitory computer readable mediums may include computer-executable instructions stored thereon that are executable by a processor to perform or cause to be performed various methods to retrieve data in a computer system with a multi-level cache. Example methods may include receiving appointment scheduling data and appointment scheduling rules corresponding to the one or more health care providers. The appointment scheduling data includes open appointment slots of practitioners of the health care providers, booked appointment slots of the practitioners of the health care providers, or combinations thereof. Further, the appointment scheduling data and the appointment scheduling rules corresponding to the one or more health care providers are stored. The appointment scheduling data and managing appointment updates for each of the one or more health care providers is processed in accordance with the appointment scheduling rules of the respective health care provider.

### BRIEF DESCRIPTION OF THE FIGURES

FIG. 1 is a block diagram illustrating integration of a health care appointment management system with one or more electronic practice managements systems (EPMs) of health care providers implemented according to aspects of the present technique;

FIG. 2 illustrates an example configuration of the health care appointment management system of FIG. 1 implemented according to aspects of the present technique;

FIG. 3 illustrates exemplary tables for storage of open, booked and available appointment slots using the health care appointment management system of FIG. 2 implemented according to aspects of the present technique;

FIG. 4 is an illustration of an example baseline synchronization process for read and write integration performed by the integration module of the health care appointment management system implemented according to aspects of the present technique;

FIG. 5 is an illustration of an example real time synchronization process for read integration performed by the integration module of the health care appointment management system implemented according to aspects of the present technique;

FIG. 6 is an illustration of an example real time synchronization process for write integration performed by the integration module of the health care appointment management system implemented according to aspects of the present technique;

FIG. 6A is an illustration of an example process implementing write integration for scheduling, creating, rescheduling, cancelling an appointment and creating a patient map to a health care scheduling system implemented according to aspects of the present technique;

FIG. 7 is an example flow diagram of one method for managing health care appointments implemented according to aspects of the present technique;

FIG. 8 is a block diagram illustrating an example computing device that is arranged for real time integration with the scheduling system of an electronic practice management (EPM) of a health care provider using real time and baseline synchronization implemented according to aspects of the present technique; and

FIG. 9 is an example computer program product that can be utilized to implement real time data integration with the scheduling system of an electronic practice management (EPM) of a health care provider in computer systems.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Example embodiments of the present technique disclose a health care appointment management system and method that facilitates real time integration with a variety of on-line and off-line electronic practice management (EPM) systems of the health care providers. As used herein, the term “EPM system” refers to health care systems configured to manage day-to-day operations of a medical practice such as a health care provider, health care clinic, and the like. Such system frequently allows a number of users to maintain patient demographics, schedule appointments, maintain lists of insurance payers, perform billing tasks, and generate reports, among others. The EPM systems may use software that can be accessed by third-party medical billing companies. In some examples, the EPM system may include desktop-only software, client-server software, or Internet-based software.

In addition, the EPM systems may include a scheduling system that allows a user such as an operator of the health care provider to create and track upcoming patient visits. In certain embodiments, the EPM system may have different appointment scheduling options such as scheduling of multiple appointments for a time slot, automatic cancellation of appointments and so forth. In some examples, appointment schedules may be color-coded to allow health care providers (e.g., doctors, nurses, assistants) to easily identify blocks of available/booked time for sets of patients.

Example embodiments of the present disclosure are generally directed to techniques for extracting and processing real time data related to appointment scheduling from one or more resources such as the EPM systems of health care providers and to publish such data on web and mobile platforms. Some example embodiments include techniques to process the appointment scheduling data and to manage appointment updates for each of the health care providers in accordance with scheduling rules of the respective health care provider.

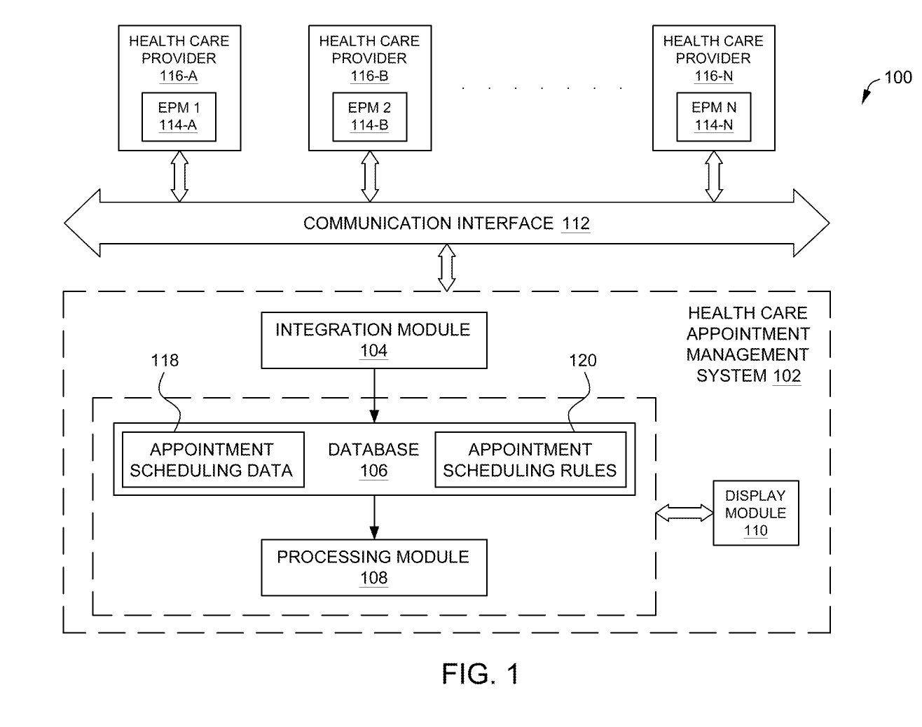

FIG. 1 is a block diagram 100 illustrating integration of a health care appointment management system 102 with one or more electronic practice managements systems (EPMs) of health care providers in accordance with at least some embodiments of the present disclosure. In the illustrated embodiment, the health care appointment management system 102 includes an integration module 104, a database 106, a processing module 108 and a display module 110. The integration module 104 is communicatively coupled to one or more electronic practice management systems (EPMs) such as generally represented by reference numerals 114-A through 114-N of one or more health care providers such as generally represented by reference numerals 116-A through 116-N. Each component of the system 102 is described in further detail below.

The system 102 facilities read and write integration with scheduling systems of one or more electronic practice management systems (EPMs) 114-A through 114-N to enable the respective health care provider to publish real time availability of practitioners of the health care providers on a variety of web and mobile platforms. Moreover, the system 102 facilitates patients to book an appointment through the system, which in turn, is automatically added in the health care provider's EPM system. Examples of one or more health care providers 116-A through 116-N include, but are not limited to, a medical practitioner, a physician, a health care provider, a hospital, a health care clinic, or combinations thereof.

The integration module 104 is configured to receive appointment scheduling data 118 and appointment scheduling rules 120 corresponding to the one or more health care providers 116-A through 116-N. Particularly, the integration module 104 is configured to receive real-time appointment scheduling data from the EPMs 114-A through 114-N of the health care providers 116-A through 116-N. Examples of appointment scheduling data 118 include, but are not limited to, open appointment slots of practitioners of the health care providers 116-A through 116-N, booked appointment slots of the practitioners of the health care providers 116-A through 116-N, or combinations thereof. Examples of appointment scheduling rules 120 of the one or more health care providers 116-A through 116-N include, but are not limited to, practice business hours, practice staff hours, holidays period, vacation period of practitioners, provider hours, provider open slots per visit reason, specific availability by a visit reason, provider overbook limit per open slot, special slots like same day slots, same day and next day slots, calendar openings with multiple bookings, patient type, appointments and procedure time by type of ailment, or combinations thereof.

The integration module 104 is communicatively coupled to the one or more electronic practice management systems 114-A through 114-N via a standard or proprietary communication interface 112. In certain embodiments, the communication interface 112 is configured to transmit a message to the integration module 104 upon an event of a new appointment, a cancellation of an existing appointment, a reschedule of an existing appointment, or combinations thereof. Examples of communication interface 112, include but are not limited to, HL7 interface, XML interface or combinations thereof. In one example, the HL7 interface includes a server/listener running and receiving HL7 messages on that pre-configured specific port from the particular scheduling system.

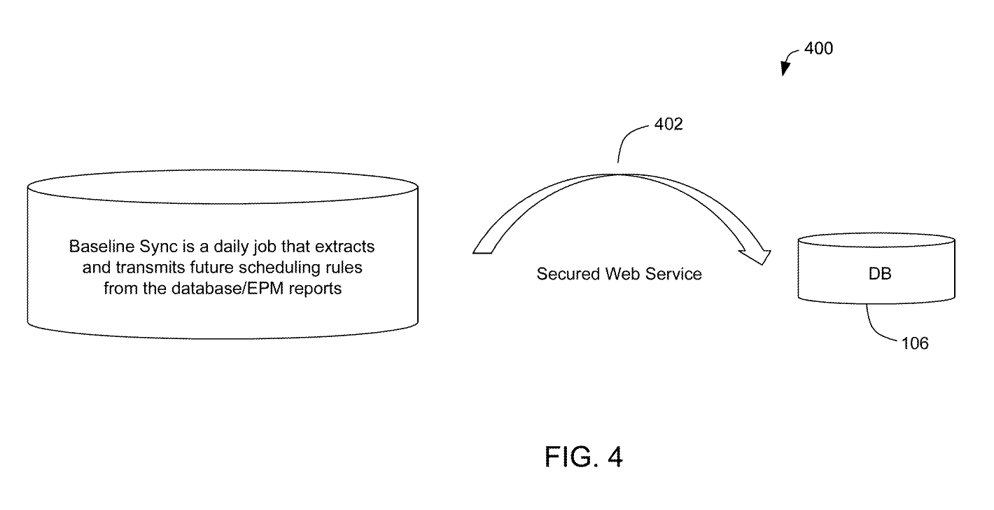

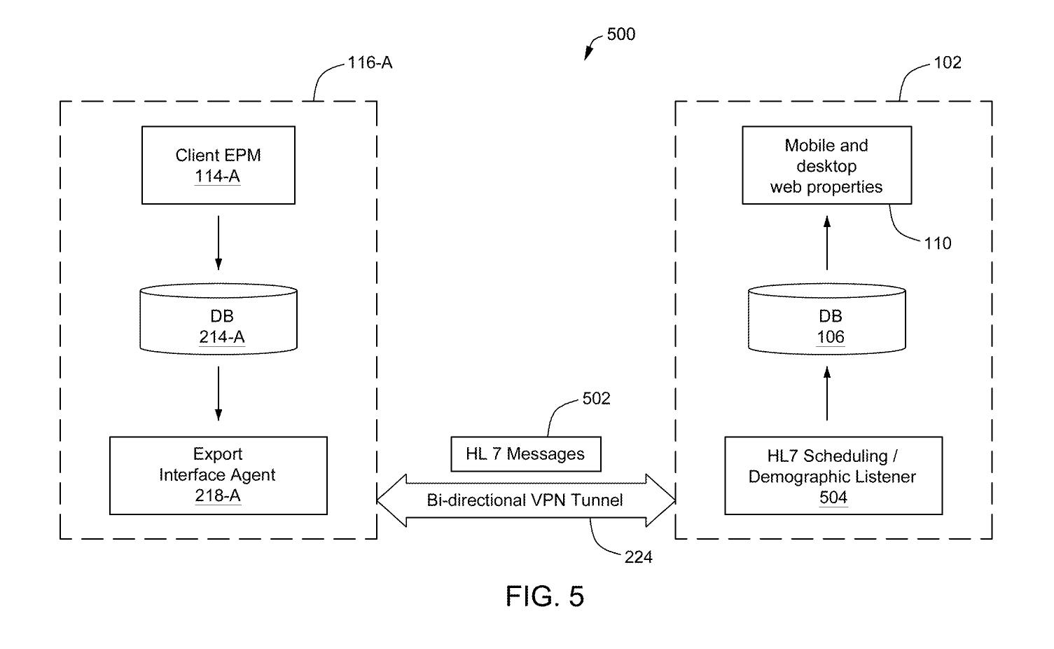

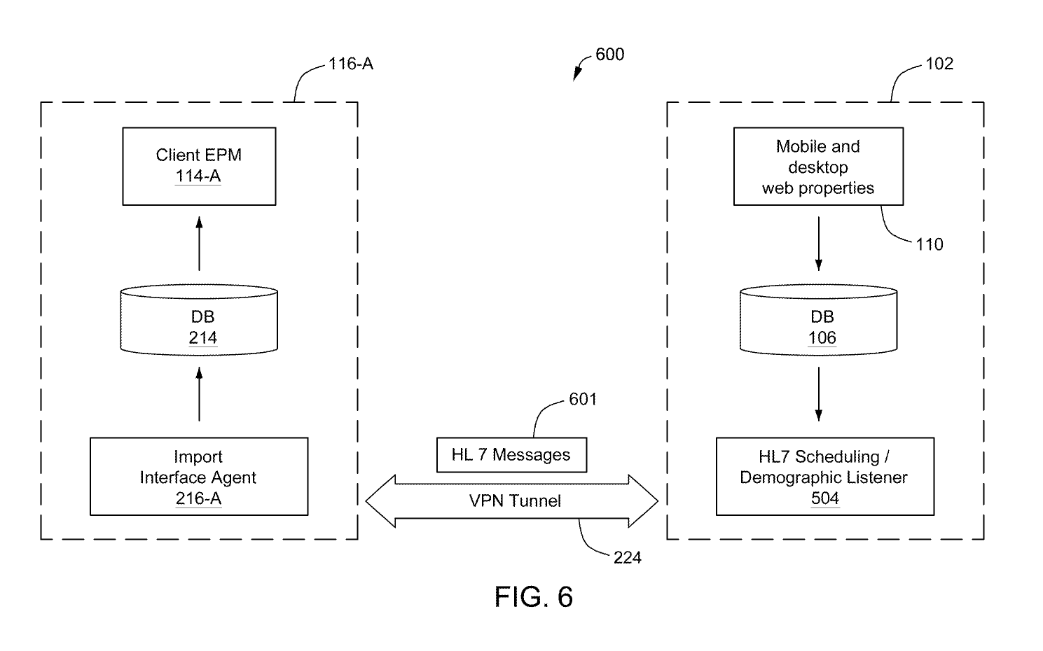

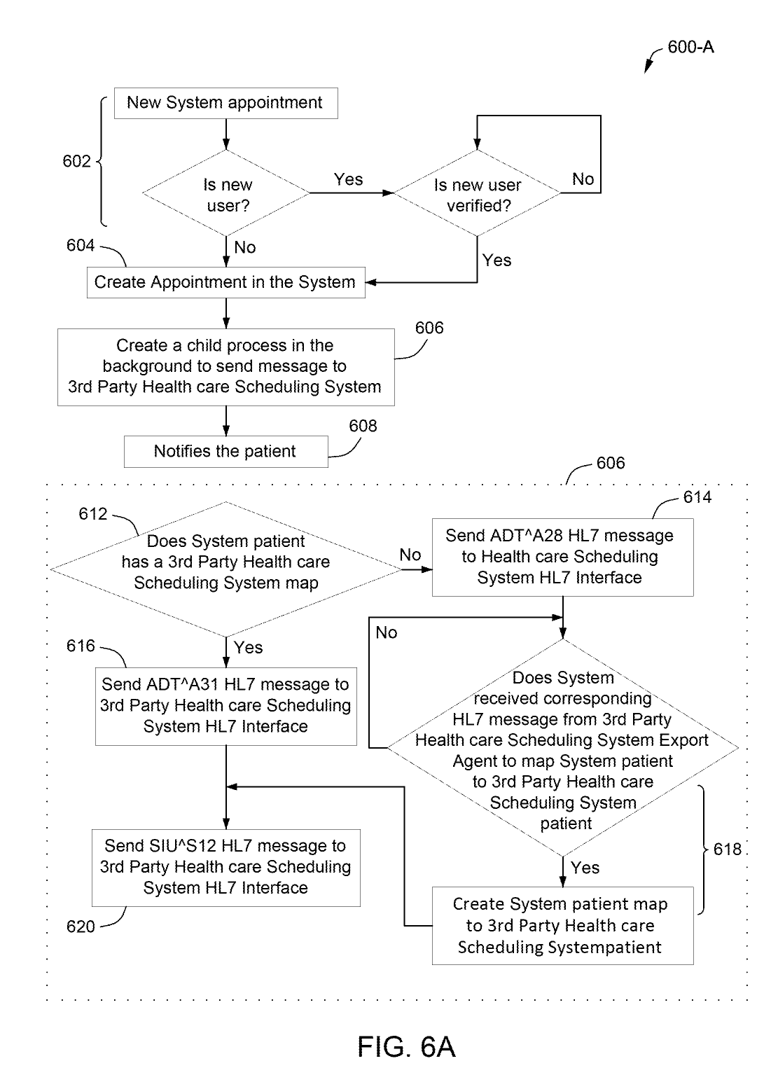

In one embodiment, the integration module 104 is configured to facilitate read and write integration with the EPMs 114-A through 114-N of one or more health care providers 116-A through 116-N using a baseline synchronization, a real-time synchronization, or combinations thereof. The baseline synchronization and a real-time synchronization are discussed with reference to FIG. 4, FIG. 5 and FIG. 6.

The database 106 is configured to store the appointment scheduling data 118 and the appointment scheduling rules 120 corresponding to the one or more health care providers 116-A through 116-N. In one embodiment, import and export operations are implemented via the integration module 104 to maintain a replica of the appointment scheduling data 118 and the appointment scheduling rules 120 corresponding to the one or more health care providers 116-A through 116-N. Such replica of the appointment scheduling data 118 and the appointment scheduling rules 120 are maintained in the database 106.

The processing module 108 is configured to process the appointment scheduling data 118 and to manage appointment updates for each of the one or more health care providers 116-A through 116-N in accordance with the appointment scheduling rules 120 of the respective health care provider. In one embodiment, the processing module 108 determines the available appointment slots for each of the one or more health care providers 116-A through 116-N in real time by integrating the appointment scheduling data with appointment updates for the corresponding health care provider.

In an example embodiment, the integration module 104 is configured to receive baseline appointment scheduling data from the EPMs 114-A through 114-N on a periodic basis using provider login credentials. Further, the processing module 108 processes the baseline appointment scheduling data and determines the availability of resources of the corresponding health care provider.

In another embodiment, the integration module 104 is configured to receive real-time appointment scheduling data from the EPMs 114-A through 114-N. Further, the processing module 108 utilizes the real-time appointment scheduling data to update the availability of resources of the corresponding health care provider. Moreover, the processing module 108 is configured to send a message to one or more patients regarding updates of the availability of resources.

The display module 110 is configured to display the available appointment slots to patients for each of the one or more health care providers 116-A through 116-N. In some examples, the display module 110 includes a website, a mobile platform managed by the health care appointment management system 102, or by a third party. The functional and operational details of health care appointment management system and integration methods with one or more electronic practice managements systems (EPMs) are described in further detail below.

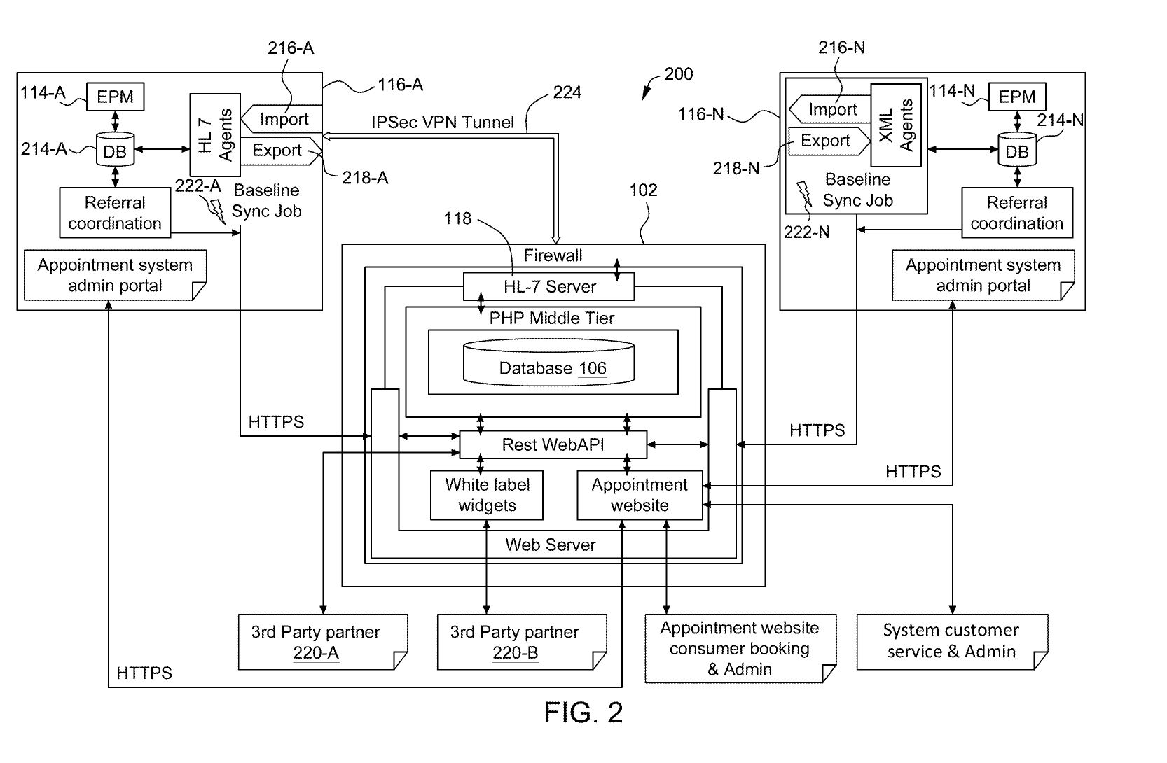

FIG. 2 illustrates an example configuration 200 of the health care appointment management system 102 of FIG. 1. In this configuration, the health care appointment management system 102 communicates with the external EPMs 114-A through 114-N of the health care providers 116-A through 116-N via standard or proprietary communication interfaces. The system 200 facilitates read and write integration operations with one or more health care provider's EPMS such as 114-A through 114-N to enable the provider to publish real time availability of the practitioners on a variety of web and mobile platforms. Moreover, the system 200 facilitates users/patients to book an appointment, which in turn, automatically gets communicated and added in the provider's electronic practice managements (EPM) system.

In this example, the processing module 108 of the health care appointment management system 102 is configured to process any change in the schedule of the health care provider's 116-A and 116-B. Such changes may be on account of addition, deletion, no-show or reschedule of any of the provider's appointments. For example, the health care provider may make changes in the schedule via different communication devices such as through phone, through online interface or through walk-ins. Further, such information is processed and the scheduling availability of the health care providers 116-A and 116-N is displayed using the display module 110 by overlapping the booked appointment information with the scheduling rules.

In the illustrated embodiment, the health care appointment management system 102 communicates with the one or more EPMs 114-A through 114-N of the health care providers 116-A through 116-N respectively over secure communication interface to maintain a replica of appointment scheduling rules and appointment scheduling data for each of the health care providers. In this embodiment, the secure communication interface includes “Health Level-7” or “HL7” that refers to a set of international standards for transfer of clinical and administrative data between hospital information systems. In an example, the real-time read and write integration operations utilize HL7/XML interface installed on the EPM of the respective health care provider.

The HL7 interface includes a server/listener (not shown) that is configured to execute and receive HL7 messages on a pre-configured specific port from the particular scheduling system. In this example, import interfaces for each of the health care providers 116-A through 116-N are represented by reference numeral 216-A through 216-N. Moreover, export interfaces are represented by reference numeral 218-A through 218-N. The integration operations are based on a push mechanism rather than pull mechanism and are performed in near real-time. The integration operations facilitate baseline synchronization and a real-time synchronization that will be discussed with reference to FIG. 4, FIG. 5 and FIG. 6.

As previously described, the system 102 utilizes various import and export operations and maintains a replica of appointment scheduling data 118 and appointment scheduling rules 120 of the health care providers (as represented by reference numerals 116-A and 116-N) in the database 106.

In another example, the import and export operations are performed using a virtual private network (VPN) tunnel 224. However, other mechanisms may be used for such operations. During the import and export operation, the health care appointment management system 102 is configured to receive blocks of available times using the customizable appointment scheduling rules 120 from the resources of the health care providers 116-A through 116-N for scheduling appointments for each block of available time on the calendar of the respective health care provider. Such information may be stored in databases such as represented by reference numerals 214-A and 214-N of the respective health care providers 116-A and 116-N.

In one example, baseline synchronization (generally represented by reference numerals 222-A and 222-N) is performed for each of the health care providers 116-A through 116-N to maintain a replica of the appointment scheduling data 118 and the appointment scheduling rules 120. In operation, a stored procedure is created by health care appointment management system 102 and the data is stored in the database 108. A daily, bi-weekly, weekly job is created in the appointment management system database 108, which calls this stored procedure.

In some embodiments, real-time synchronization is performed to maintain the replica of information, and the health care appointment management system 102 may maintain a separate list of currently booked appointments. Further, any change in the availability in accordance to the booked appointments and appointment scheduling rules set forth by the health care provider may be processed to update available slots.

As described before, the health care appointment management system 102 utilizes the processing module 108 to process the appointment scheduling data 108 such as open blocks of times and the booked appointments slots in accordance with the appointment scheduling rules 120. The processed information is then available to determine available appointments in the schedule of the respective health care provider such as 116A and can be booked by a user. The details of the booked appointments and available appointments may be made available to a user via a variety of communication channels website for the health care appointment management system 102, or a number of third party partner managed resources (like third party websites), such as represented by reference numerals 220-A and 220-B.

In some embodiments, the health care appointment management system 102 stores information for each health care center, health care provider, or a pool of providers by visit reason (i.e., appointment type/reason). Such information includes scheduling rules, open appointment slots and booked appointment slots. Further, the health care appointment management system 102 uses the appointment scheduling rules 120 and the appointment scheduling data 118 such as information regarding the open and booked slots to determine the available booking slots that are displayed (using the display module 110) to the users.

In one example embodiment, the health care appointment management system 102 obtains the scheduling rules from each of the health care provider. Examples of the scheduling rules include, but are not limited to, to practice business hours, practice staff hours, holidays period, vacation period of practitioners, provider hours, provider open slots per visit reason, specific availability by a visit reason, provider overbook limit per open slot, special slots like same day slots, same day and next day slots, calendar openings with multiple bookings, patient type, appointments and procedure time by type of ailment, or combinations thereof.

In another example, the health care appointment management system 102 maintains a complete separate list of booked appointments. In any event of a new appointment, cancelled appointment or reschedule of existing appointment in the electronic practice management (EPM) system of the health care provider, the list of booked appointments is updated. Further, booked appointment slots information can be imported in different ways. In one example, the health care appointment management system 102 performs real time integration with the EPM (for e.g. 114-A) of the health care provider (e.g., 116-A) through HL7 interface. The HL7 interface is an event driven interface, which sends a HL7 message in any event of new appointment and cancel/reschedule existing appointment in the EPM.

In another example, the health care appointment management system 102 installs an application on the EPM server. The application pulls any change in the booked appointments list from EPM database (as represented by reference numerals 214-A and 214-N) periodically and uses secured web services to pass that information to the health care appointment management system 102.

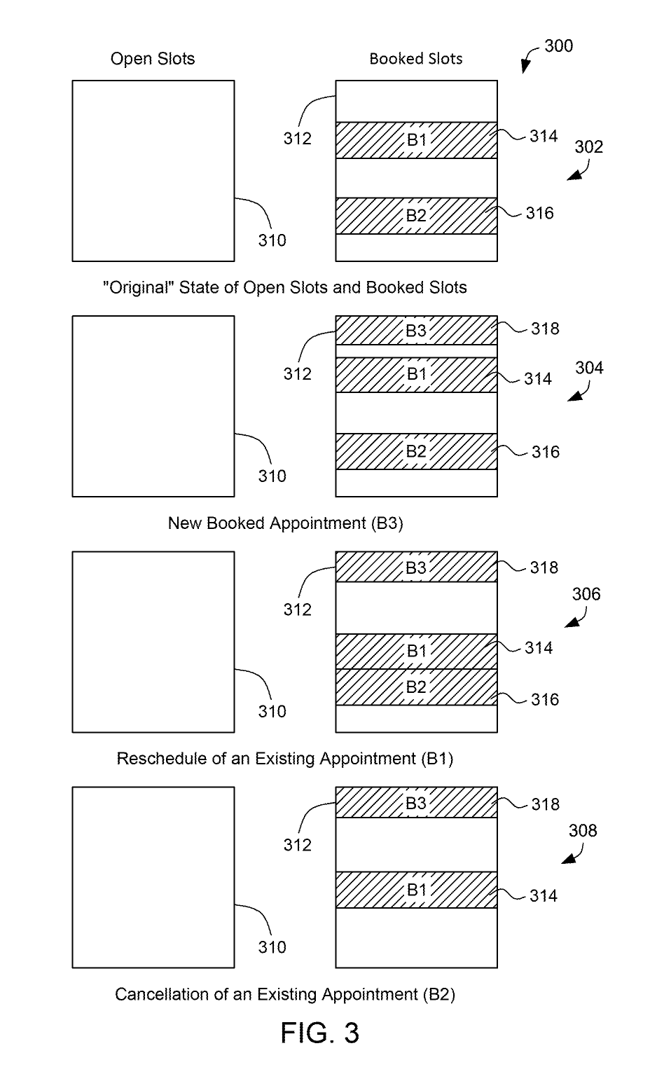

Furthermore, the health care appointment management system 102 provides a secured file transfer protocol (FTP) account. In this FTP account, the EPM puts the “change” information of the booked appointments in a CSV or XML file format. Due to this “change” information, the health care appointment management system 102 automatically reads and updates the information in the database 106. In addition, the health care appointment management system 102 automatically updates the changes in the appointments done through communication channels, but provider updates the rest of the changes manually through the appointment management system 102 web portal. In addition, the health care appointment management system 102 stores both open slots and booked slots information in distinct database tables. The storage of open and booked slots is described with reference to FIG. 3.

FIG. 3 illustrates exemplary tables 300 for storage of open, booked and available appointment slots using the health care appointment management system 102 of FIG. 2. In this example, an original state of the open slots and booked slots is represented by reference numeral 302 and a state of new booked appointment is represented by reference numeral 304. Further, a reschedule of an existing appointment is represented by reference numeral 306 and a cancellation of an existing appointment is represented by reference numeral 308. Each of these states includes an open slots table 310 and a booked slots table 312.

As can be seen, in the original state 302, there are two booked slots B1 and B2, generally represented by reference numerals 314 and 316 indicated in the booked slots table 312. Further, as can be seen in table 304, in the state of addition of a new appointment B3 (represented by reference numeral 318), the appointment 318 is added to the booked slots table 312. Similarly, as illustrated in table 306, in case of a reschedule of the appointment B1, the appointment B1 is moved to a new position in the booked slots table 312. Further, as illustrated in table 308, in an event of cancellation of the appointment B2 316, the appointment 316 is deleted from the booked slots table 312. It should be noted that, updates to the appointments such as addition of a new appointment, cancellation of an existing appointment and reschedules of the existing appointment are made in the booked slots table 312 and no changes are made to the open slots table 310.

The information regarding the open and booked slots may be displayed to the users in a variety of formats. In one embodiment, the available slots are coupled with appointment duration information to determine accurate start time of an appointment and such start time of the appointment is displayed to the patients/users of the system.

In another embodiment, the health care appointment management system 102 determines available slots based on the open slots and the booked slots. For example, the open slots are determined for a selected visit reason and a health care provider, based on the appointment scheduling rules. Further, the existing booked slots are determined for the respective health care provider. Subsequently, such information regarding the open slots and booked slots is processed in accordance with the appointment scheduling rules to determine availability of the health care provider.

In another example, the available slots are displayed as appointment start times that is determined based on appointment duration information such as visit reason duration at the practice level of the practitioner attending the patient, standard visit reason duration at the specialty level, visit reason duration at the provider level or minimum slot duration and so forth.

The health care appointment management system 102 described above facilitates read and write integration with EPM of the health care providers. The read and write integration with EPM of the health care providers allows the health care appointment management system 102 to automatically read and synchronize the availability (e.g. open slots and booked slots) of each health care provider (e.g., center, resources, practitioner etc.). Moreover, the health care appointment management system 102 also allows to insert new appointments such as booked through various web/mobile channels directly in the EPMs of the health care provider. The integration may be performed through baseline or real-time synchronization.

FIG. 4 is an illustration of an example baseline synchronization process 400 for read and write integration performed by the integration module 104 of the health care appointment management system 102 according to aspects of the present technique. The baseline synchronization process 400 may be implemented as a daily, bi-weekly and/or a weekly job in the EPM database (e.g., 214-A through 214-N) of the health care providers (e.g., 116-A through 116-N) respectively. As illustrated by step 402, a stored procedure is created and executed by the health care appointment management system 102 and the appointment scheduling data and the appointment scheduling rules are is stored in the database 108. In one embodiment, the baseline synchronization process 400 is a daily job that extracts future scheduling rules from the EPM database (e.g., 214-A through 214-N) of the health care providers (e.g., 116-A through 116-N) or EPM reports and transmits the data via secured web services or secured file transfer.

In one embodiment, a variety of parameters are utilized to setup the baseline synchronization on any EPM (e.g., 114-A through 114-N) of the one or more health care providers (e.g., 116-A through 116-N). The parameters may be stored in the EPM's database (e.g., 214-A through 214-N). In one embodiment, the parameter includes a resource of a health care provider. For example, the resource may be a center, a physician, a group of physician's, an inventory, a single practitioner, or combinations thereof. In another example, the parameter includes a physical location of the resource. In another example, the parameter includes a visit reason of visit for which a resource such as any of the health care providers 116-A through 116-N may provide service. Such parameters alone or in combination may be stored in the database (e.g., 214-A through 214-N). A variety of other parameters may be envisaged.

In some embodiments, the baseline synchronization is utilized to extract information such as availability of a resource at a particular location for a particular visit reason. Here, the health care appointment management system 102 extracts the health care provider's resource open availability for each visit reason and location by looking at the different availability templates existing in the system 200. Moreover, the health care appointment management system 102 extracts information associated with resource's booked times for the particular location.

In some embodiments, the baseline synchronization process further facilitates the verification and its access of the health care providers (e.g., 116-A through 116-N). In one embodiment, the communication interface 112 is configured to read post input XML text, and to extract information regarding the identification and credentials for verification of the health care providers (e.g., 116-A through 116-N). In operation, mismatch of the credentials may trigger the communication interface 112 to return a ‘Login Failed’ response. In addition, the communication interface 112 may also create the log file.

Furthermore, the communication interface 112 may also verify the open appointments and/or or booked appointments information of one or more health care providers (116-A through 116-N). Based on open appointments slots information, the system 200 may determine the date and availability of all the resources for events for that date. Then, the system 200 may combine the open appointment slots based on a start time, an end time, and overbook limit and further stores the contiguous blocks which has final start time, end time and overbook limit in the database 108.

The table below describes an example scenario for the open appointment slots for a particular location, resource and event combination for any of a particular health care provider 116-A through 116-N:

TABLE 1

| Start Time | End Time | Overbook Limit |
|---|---|---|
| 8:00 am | 8:10 am | 2 |
| 8:10 am | 8:20 am | 2 |
| 8:20 am | 8:30 am | 1 |
| 8:30 am | 8:40 am | 1 |
| 9:30 am | 9:40 am | 1 |
| 9:40 am | 9:50 am | 1 |

For the above example, the final open availability blocks for any of a particular health care provider 116-A through 116-N stored in the database 106 are as shown in Table. 2

TABLE 2

| Start Time | End Time | Overbook Limit |
|---|---|---|
| 8:00 am | 8:20 am | 2 |
| 8:20 am | 8:40 am | 1 |
| 9:30 am | 9:50 am | 1 |

Moreover, based on the booked slots information, the health care appointment management system 102 reads all the data related to booked times and directly stores such data in the database 108.

In one embodiment, the stored procedure is created on a third party health care scheduling system database (e.g., 214-A of FIG. 2). In addition, the stored procedure takes time period in terms of days as an input parameter. Furthermore, the stored procedure takes the system date and adds the input parameter of time period to get the end date.

In one example, for each date from system date to the end date, the stored procedure gets the open appointment slots, i.e. begin time, duration and overbook limit, for each location, resource and event combination on a particular date by mapping categories to categories members to get the events to which category gets applied. In addition, the stored procedure gets the open availability, i.e. begin time, duration and overbook limit, for each location, resource and event combination on a particular date by mapping categories to appointment slots to get the availability (date, time, duration and overbook limit) of resources. In this example, several events/visit reasons of the patients are grouped together to form a category. The scheduling rules are created for each category and are applied to the category. This information is extracted in XML format and is sent to the server by calling the secured web service using the login credentials of the respective health care provider (e.g., 116-A through 116-N).

In another example, for each date from system date to the end date, the stored procedure determines all the active booked appointment slots (with cancel, delete and reschedule indicator as 0), i.e. begin time, end time, HL7 interface appointment id for each location, resource and event combination on a particular date by mapping appointments to appointment members to get the resource used for the appointment. In addition, the stored procedure gets all the active booked slots (with cancel, delete and reschedule indicator as 0), i.e. begin time, end time, HL 7 interface appointment id for each location, resource and event combination on a particular date by mapping appointments to interface appointment to get the interface appointment id which is passed by HL7 interface for real time synchronization of that appointment to the appointment management system.

This information is extracted in XML format and is passed to health care scheduling server by calling the secured web service using the login credentials of the respective health care provider (e.g., 116-A through 116-N). For conciseness, a daily, bi-weekly, weekly job is created in the health care scheduling system database, which calls this stored procedure. The manner in which the real time synchronization is performed is described further in FIG. 5 and FIG. 6 respectively.

FIG. 5 is an illustration of an example real time synchronization process 500 for read integration performed by the integration module 104 of the health care appointment management system 102 according to aspects of the present technique. The real time synchronization process 500 is triggered by scheduling events, such as ‘new’, ‘cancel’, or ‘reschedule appointment’. On an event of booking of a new appointment, or cancelling or rescheduling of an already booked appointment, this process updates the scheduling system of the EPM of the health care provider in real time. The real time synchronization is triggered by HL7 messages as indicated by reference numeral 502.

As described before, the health care appointment management system 102 is communicatively coupled to the electronic practice management system (EPM) 114-A of a health care provider 116-A. The EPM 114-A includes a health care scheduling system. The health care provider 116-A includes a HL7 export interface agent 218-A used as an interface between the health care provider 116-A and the health care appointment management system 102. The health care appointment management system 102 forms a site-to-site IPSec VPN tunnel (as represented by reference numeral 224) for secured communication of the HL7 messages 502 between a HL7 scheduling and demographic listener 504 of the health care appointment management system 102 and the export interface agent 218-A of the health care provider 116-A.

The read integration with the health care scheduling system of the electronic practice management (EPM) 114-A of the health care provider 116-A using real time synchronization is described below.

In an example, on an event of any new booked appointment or a change in any existing booked appointment in the health care scheduling system of the EPM 114-A of the health care provider 116-A, HL7 export interface agent 218-A sends the pertinent HL7 message 502 to the server on a pre-configured specific port number through VPN tunnel 224. The health care appointment management system 102 has a scheduling and demographic listener 504 running and receiving HL7 messages 502 on that pre-configured specific port from the particular scheduling system instance. The health care appointment management system 102 interprets the HL7 message 502 and makes equivalent change for that provider/resource in the server module (not shown) such as health care scheduling server to keep the schedules always synchronized with that health care scheduling system existing in EPM 114-A.

In one example, when the HL7 message 502 is for a new scheduled appointment then the health care appointment management system 102 adds the appointment (e.g., health care scheduling system appointment ID, location, resource, event, start date-time, end date-time) in the booked appointment slots table stored in database 214-A. In case, the new scheduled appointment has an appointment ID of the health care appointment management system 102, then the health care scheduling system appointment ID is mapped with health care appointment management system appointment ID in the database 106.

In another example, when the HL7 message 502 is for cancellation of an appointment then the corresponding appointment record is removed in booked appointment slots table stored in database 214-A. When the appointment created by the health care appointment management system 102 is cancelled, then appointment management system 102 also informs about the appointment cancellation to the corresponding patient via email or text depending upon a notification preference chosen by the patient.

In another example, when the HL7 message 502 is for reschedule of appointment then the new appointment information (e.g. health care scheduling system appointment ID, location, resource, event, start date/time, end date/time) is added to the booked appointment slots table stored in database 214-A. The reschedule message is accompanied by the cancellation message, which removes the old booked appointment slot from the booked appointment slots table. In this embodiment, in case the appointment created by the health care appointment management system 102 is rescheduled, then the system also informs about the reschedule of appointment to the patient via email or text depending upon the notification preference chosen by the patient.

The reschedule message may not include any reference of the old appointment identification that has been rescheduled. In order to determine, that the reschedule is for appointment created by the appointment management system 102, the reschedule appointment is first identified for the corresponding patient by looking at the health care scheduling system patient id and further searching it in the database 106 to verify in case of any patient id is mapped to this health care scheduling system patient id.

In this example embodiment, when a reschedule of an appointment is for a particular ‘patient id’ already existing in the database 106 of the appointment management system 102, then the system verifies to check whether there has been any cancellation of the appointment for this particular patient id. Also, in case of the reschedule of the appointment for the same patient id of the appointment management system 102, the system may check for any cancellation of the appointment with the same provider-location or different provider-location within the same organization. Similarly, when a reschedule of an appointment is for a particular ‘patient id’ already existing in the database 106 of the appointment management system 102, then the system may check for any cancellation of the appointment by the practice.

In addition, when reschedule is for patient id of the appointment management system 102, then the system may check for any cancellation of the appointment within a specified time period such as for the last half an hour time frame. In case of cancellation of the appointment within last half an hour time frame, the system marks this as the reschedule of the previous cancelled appointment of patient of the appointment management system 102.

In another example, when the HL7 message 502 is for the update of an appointment for a particular patient id, then the system may check the update for the appointment already present in the appointment management system 102. Based on the verification of the update of an appointment, the update of the appointment is KEPT which helps in finding the NOSHOW rate. Furthermore, when the HL7 message 502 specifies ‘NOSHOW’ appointment notification), then the system may check the notification for the appointment already present in the appointment management system 102. After verification, the appointment status as NOSHOW is updated in the database 106 of the appointment management system 102.

In another example, when the HL7 message 502 is a demographic message, then the system may check the message with a ‘patient id’ of the appointment management system 102. After verification, the health care scheduling system ‘patient id’ is extracted and updates are made to map the ‘patient id’ with health care scheduling system ‘patient id’ in the database 106 of the appointment management system 102.

In another example, when the HL7 message 502 is the patient merge message, then the system verifies to check for the merged patient with patient already existing in the database 106 of the appointment management system 102. Based on the verification, the system then replaces the mapped health care scheduling system patient id with the health care scheduling system patient id of the retained patient. Moreover, the appointment management system 102 also keeps the shadow demographics record from provider health care scheduling system for the patients mapped to provider health care scheduling system patient. This shadow data is only used for any further transactions of the patient with that provider's health care scheduling system instance.

FIG. 6 is an illustration of an example real time synchronization process 600 for write integration performed by the integration module 104 of the health care appointment management system 102 according to aspects of the present technique. The real time synchronization process 600 is triggered by scheduling events, such as ‘new’, ‘cancel’, or ‘reschedule appointment’. The real time synchronization is triggered by HL7 messages as indicated by reference numeral 601.

In operation, upon detection of an event of any new booked appointment or change in existing booked appointment in the server of the health care appointment management system 102, the system creates the pertinent scheduling or demographic message and sends it to the health care scheduling system instance's IP address at preconfigured port on health care scheduling system side through the VPN tunnel 224. In this example, the import interface agent 216-A receives the HL7 message 601 and makes appropriate changes in the database 214 as well as sends back an acknowledgement. In case of any problems in the message, import interface agent 216-A may transmit back an error acknowledgement as the acknowledgement status.

The write integration with the healthcare scheduling system of the electronic practice management (EPM) 114-A of the health care provider 116-A using real time synchronization is described with reference to FIG. 6A below.

FIG. 6A is an illustration of an example process implementing write integration for scheduling, creating, rescheduling, cancelling an appointment and creating a patient map for a health care scheduling system. The word ‘patient’ and ‘user’ may be used interchangeably in the description below.

At block 602, a patient books a new appointment with the health care scheduling system of the EPM 114-A of the health care provider 116-A. In one embodiment, the patient is authenticated to confirm its existence in the database 106 of the health care appointment management system 102. For a first time user of the appointment management system 102, the booking of appointment is not sent to the health care scheduling system of the EPM 114-A of the health care provider 116-A until the new user verifies his/her phone number provided to system.

At block 604, an appointment is created for the patient and/or user. In one embodiment, as soon as the user is verified and the user books an appointment, the appointment is created in the database 106. At block 606, the appointment generates a child process in the background. The child process may include one or more steps to send the appointment to the health care scheduling system server of the EPM 114-A. At block 608, the patient is notified regarding the created appointment. The patient is notified via email or text depending upon the notification preference chosen by the patient. The child process 606 includes steps (represented by reference blocks 612-620) to send the notification to the health care scheduling system server of EPM 114-A. The 3rd Party Health care Scheduling System as illustrated in FIG. 6-A represents health care scheduling system server of EPM 114-A.

At block 612, the existence of the health care scheduling system map in the patient id of the patient is examined. At block 614, in absence of any map of the patient to the health care scheduling system in the database 106, the scheduling and demographic listener 504 sends an HL7 message with patient demographics and insurance information.

Once the existence of the map of the patient to the health care scheduling system in the database 106 is verified, the health care scheduling system import interface 216-A runs the patient matching algorithm to check whether the patient already exists in the health care scheduling system of the EPM 114-A (block 616). At this block, the existence of the patient facilities the health care scheduling system to map the patient id of the system 102 to the existing health care scheduling system patient id and export interface agent 218-A then generates and sends back message to the system 102.

At block 618, when matching of patient map to any existing health care scheduling system patient fails, then new patient record is created in health care scheduling system and is mapped to the patient id of the system 102, followed by the export interface agent sending message back to system 102. When system 102 receives the messages from the interface, the message has both patient id of the system 102 and health care scheduling system patient id, and the system 102 reads both the ids and adds the mapping of patient id to health care scheduling system patient id in the database 106.

At block 620, the appointment management system 102 sends a HL7 message with health care scheduling system appointment id in the background. In one embodiment, when a patient cancels any appointment with health care scheduling system instance provider, then it cancels the appointment in database 106, and sends the HL7 message with health care scheduling system appointment id in the background. Similarly, when a patient reschedules any appointment with health care scheduling system instance provider, then it first books the new appointment in the health care appointment management system 102 and when successful, then cancels the old appointment in system 102 and sends the messages in the background.

In one embodiment, the health care scheduling system of the EPM includes an internal tool “Search Ahead Appointment” that works on temporary tables to find available open appointment slots for any location, resource and event. These temporary tables are not updated automatically by the health care scheduling system import interface agent to account for any new/cancel/reschedule appointment from online appointment scheduling (OAS) platform. In operation, to enable the “Search Ahead Appointment” tool to show real time availability, the health care appointment management system 102 includes a the trigger on the health care scheduling system interface appointment table. For every new insert on this table, leads to trigger of a stored procedure, which reads the new added record and updates the temporary table, read by “Search Ahead Appointment” tool.

In another embodiment, the system 102 utilizes a custom hierarchical patient matching algorithm that may include several stages as described below.

For example, at a first stage, the system 102 matches patient last name, first name, date of birth and social security number (SSN) between the provided patient information to system 102 and every health care scheduling system existing patient record. In case of a match at first stage, the system maps the patients else the second stage of the patient matching algorithm is executed. At second stage, the system 102 matches patient last name, first name, date of birth and home phone number between provided patient information to the system 102 and every health care scheduling system existing patient record. In case of a match at second stage, the system maps the patients else the third stage of the patient matching algorithm is executed.

At third stage, the system 102 matches the patient last name, first name, date of birth and day/work phone number between provided patient information to the system 102 and every health care scheduling system existing patient record. In case of a match at third stage, the system maps the patients else the fourth stage of the patient matching algorithm is executed. At fourth stage, the system 102 matches patient last name, first name, date of birth and cellphone number between the provided patient information to system 102 and every health care scheduling system existing patient record. In case of a match at fourth stage, the system maps the patients else the fifth stage of the patient matching algorithm is executed.

At fifth stage, the system 102 matches patient last name, first name, date of birth and alternate phone number between the provided patient information to system 102 and every health care scheduling system existing patient record. In case of a match at fifth stage, the system maps the patients else the sixth stage of the patient matching algorithm is executed. At sixth stage, the system 102 matches patient last name, first name, date of birth and email between provided patient information to system 102 and every health care scheduling system existing patient record. In case of a match at sixth stage, the system maps the patients else the seventh stage of the patient matching algorithm is executed.

At seventh stage, the system 102 matches patient last name, first name, date of birth and zip between provided patient information to system 102 and every health care scheduling system existing patient record. In case of a match the system then maps, else, creates a new record.

In the same embodiment, when the database 106 of the system 102 already has the map of the patient of the system 102 with the health care scheduling system patient, then it sends a HL7 message to communicate and update any change in the patient's demographics and insurance information in health care scheduling system. As soon as database 108 has the mapping of patient of the system 102 with health care scheduling system patient id, it sends the HL7 message, i.e. new appointment message with health care scheduling system patient id, resource id, location id, event id, appointment date and time information. The health care scheduling system import interface receives the HL7 message, adds the appointment in health care scheduling system, and adds the mapping of the health care scheduling system appointment id with appointment id of the system 102 in its interface appointment table. This triggers the export interface agent to send the message, which has health care scheduling system appointment id and patient id of the system 102 back to the system 102. The system 102 receives the message and adds the mapping of system 102 appointment id with the health care scheduling system appointment id.

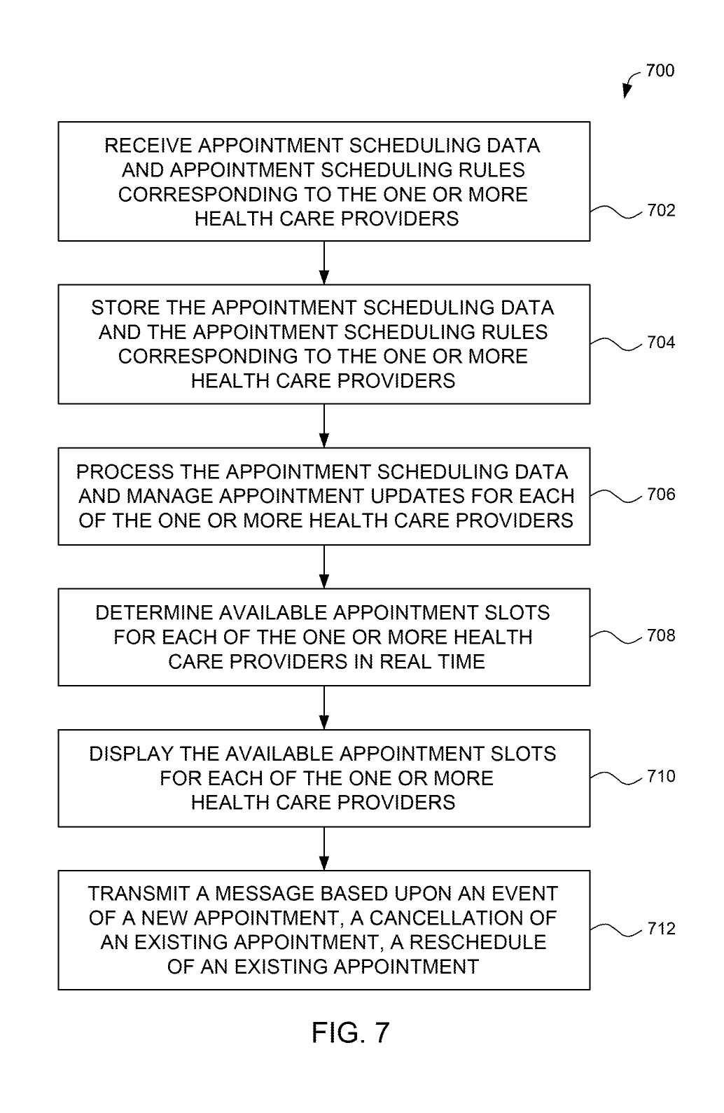

FIG. 7 is an example flow diagram of one method for managing health care appointments. Each step is described in further detail below.

At block 702, appointment scheduling data and appointment scheduling rules corresponding to one or more health care providers are received by an integration module of a health care appointment management system. At this block, real-time appointment scheduling data from electronic practice management systems of the one or more health care providers is received. Examples of the appointment scheduling data includes, but is not limited to, open appointment slots of practitioners of the health care providers, booked appointment slots of the practitioners of the health care providers, or combinations thereof.

Examples of the appointment scheduling rules of the one or more health care providers include, but are not limited to, practice business hours, practice staff hours, holidays period, vacation period of practitioners, provider hours, provider open slots per visit reason, specific availability by a visit reason, provider overbook limit per open slot, calendar openings with multiple bookings, patient type, appointments and procedure time by type of ailment, or combinations thereof.

At block 704, the appointment scheduling data and the appointment scheduling rules corresponding to the one or more health care providers are stored in a database of the health care appointment management system. In one embodiment, various import and export operations are implemented to maintain a replica of the appointment scheduling data and the appointment scheduling rules corresponding to the one or more health care providers.

At block 706, the appointment scheduling data for each of the one or more health care providers is processed via a processing module of the health care appointment management system. Further, the appointment updates of the one or more health care providers are managed. At block 708, the available appointment slots for each of the one or more health care providers are determined in real time via the processing module of the health care appointment management system. In one embodiment, the available appointment slots for each of the one or more health care providers are determined in real time by integrating the appointment scheduling data with appointment updates for the corresponding health care provider.

In this embodiment, the appointment scheduling data is processed by the processing module of the health care appointment management system and the availability of resources of the corresponding health care provider is determined. Further, the real-time appointment scheduling data to is utilized to update the availability of resources of the corresponding health care provider.

At block 710, the available appointment slots for each of the one or more health care providers are displayed via a display module of the health care appointment management system. In one embodiment, the available appointment slots is displayed to patients for each of the one or more health care providers. For example, a website, a mobile platform managed by the health care appointment management system or by a third party is used to display available appointment slots. At block 712, a message based upon an event of a new appointment, a cancellation of an existing appointment, a reschedule of an existing appointment is transmitted. In one embodiment, the message is sent to the patient via email or text depending upon the notification preference chosen by the patient.

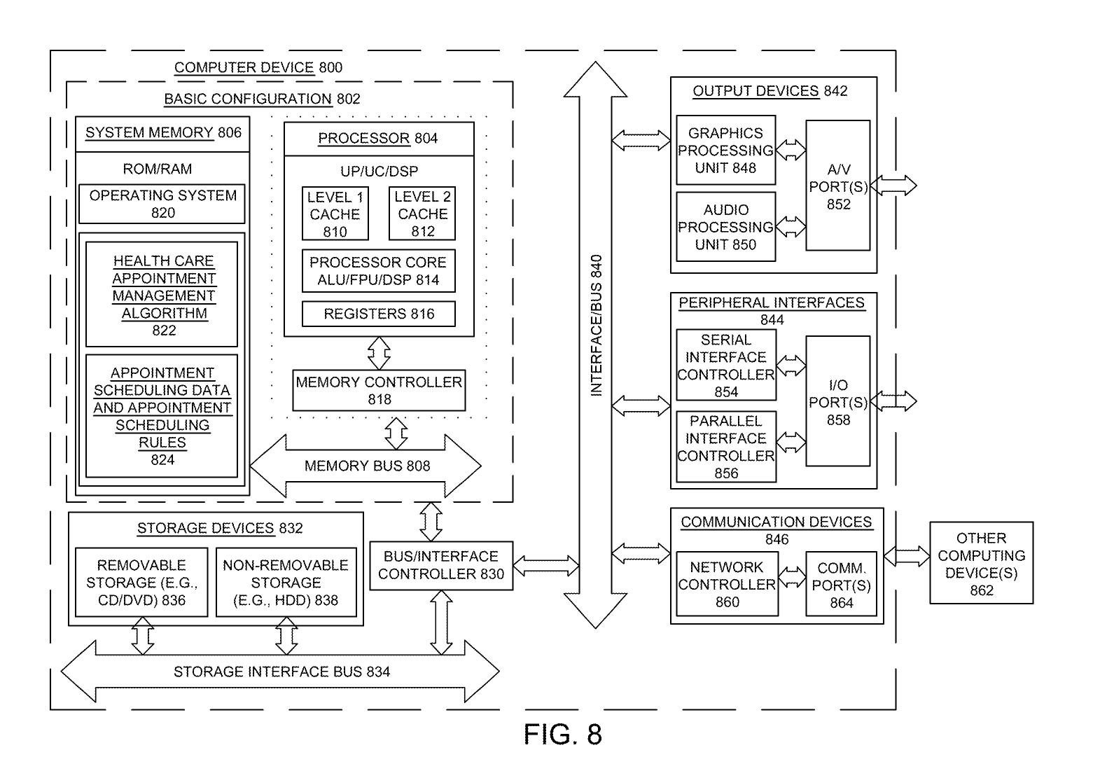

FIG. 8 is a block diagram illustrating an example computing device 800 that is arranged for real time integration with the scheduling system of an electronic practice management (EPM) of a health care provider using real time and baseline synchronization with at least some embodiments of the present disclosure. In a very basic configuration 802, the computing device 800 typically includes one or more processors 804 and a system memory 806. A memory bus 808 may be used for communicating between processor 804 and system memory 806. The processor 804 includes a multi-core processor.

Depending on the desired configuration, processor 804 may be of any type including but not limited to a microprocessor (μP), a microcontroller (μE), a digital signal processor (DSP), or any combination thereof. Processor 804 may include one more levels of caching, such as a level one cache 810 and a level two cache 812, two or more processor cores 814, and registers 816. An example processor core 814 may include an arithmetic logic unit (ALU), a floating point unit (FPU), a digital signal processor core (DSP Core), or any combination thereof. An example memory controller 818 may also be used with processor 804, or in some implementations memory controller 818 may be an internal part of processor 804.

Depending on the desired configuration, system memory 806 may be of any type including but not limited to volatile memory (such as RAM), non-volatile memory (such as ROM, flash memory, etc.) or any combination thereof. System memory 806 may include an operating system 820, one or more applications 822, and program data 824. In some embodiments, application 822 may be arranged to operate with program data 824 on operating system 820. This described basic configuration 802 is illustrated in FIG. 8 by those components within the inner dashed line. Application 822 may include algorithm to facilitate real-time management of health care appointments. Program data may include appointment scheduling data and appointment scheduling rules required for managing health care appointments.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 806, removable storage devices 836 and non-removable storage devices 838 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of computing device 800.

Computing device 800 may also include an interface bus 840 for facilitating communication from various interface devices (e.g., output devices 842, peripheral interfaces 844, and communication devices 846) to basic configuration 802 via bus/interface controller 830. Example output devices 842 include a graphics processing unit 848 and an audio processing unit 850, which may be configured to communicate to various external devices such as a display or speakers via one or more A/V ports 852.

Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 800 may also be implemented as a personal computer including both laptop computer and non-laptop computer configurations.

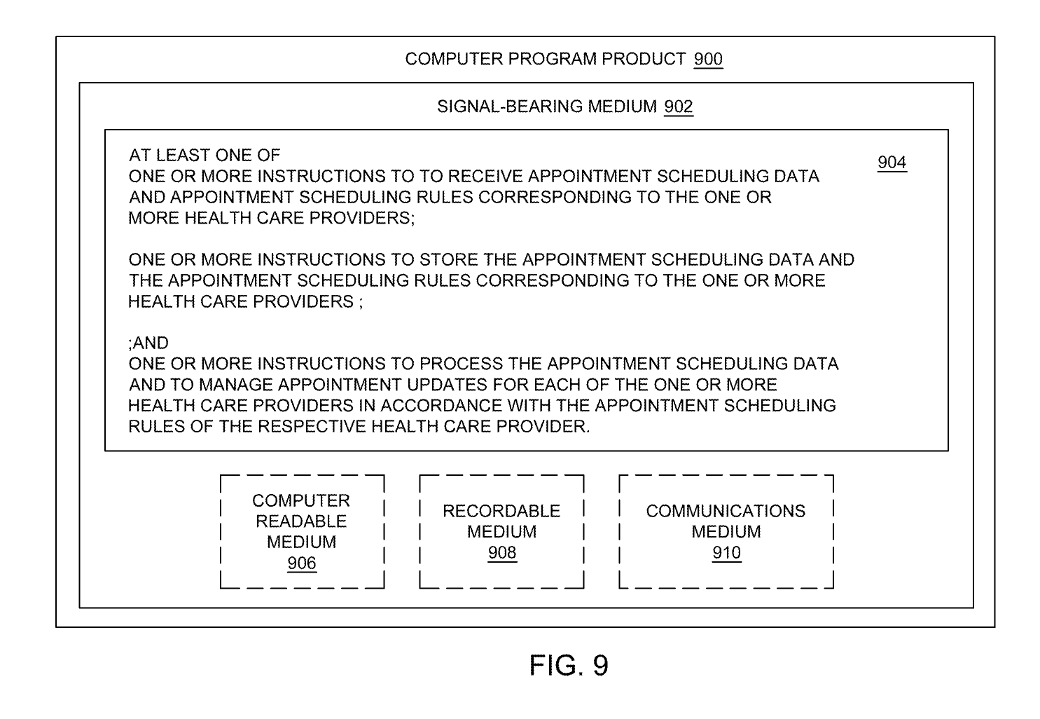

FIG. 9 is an example computer program product that can be utilized to implement real time data integration with the scheduling system of an electronic practice management (EPM) of a health care provider in computer systems. Program product 900 may include a signal bearing medium 902. Signal bearing medium 902 may include one or more instructions 904 that, in response to execution by, for example, a processor, may provide the features described above with respect to FIGS. 1-8. Thus, for example, referring to system 100, the health care appointment management system 102 may undertake or cause to be undertaken the operations depicted in one or more of the blocks shown in FIG. 9 in response to instructions 904 conveyed to the system 100 by medium 902 and then executed.

In some implementations, signal bearing medium 902 may encompass a non-transitory computer-readable medium 906, such as, but not limited to, a hard disk drive, a Compact Disc (CD), a Digital Video Disk (DVD), a digital tape, memory, etc. In some implementations, signal bearing medium 902 may encompass a recordable medium 608, such as, but not limited to, memory, read/write (R/W) CDs, R/W DVDs, etc. In some implementations, signal bearing medium 902 may encompass a communications medium 910, such as, but not limited to, a digital and/or an analog communication medium (e.g., a fiber optic cable, a waveguide, a wired communications link, a wireless communication link, etc.). Thus, for example, program product 900 may be conveyed to one or more modules of the system 100 by an RF signal bearing medium 902, where the signal bearing medium 902 is conveyed by a wireless communications medium 910 (e.g., a wireless communications medium conforming with the IEEE 802.11 standard).

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A health care appointment management system comprising:
an integration module communicatively coupled to one or more electronic practice management systems (EPMs) of one or more health care providers, wherein the integration module is configured to receive appointment scheduling data and appointment scheduling rules corresponding to the one or more health care providers
a database configured to store the appointment scheduling data and the appointment scheduling rules corresponding to the one or more health care providers; and
a processing module configured to process the appointment scheduling data and to manage appointment updates for each of the one or more health care providers in accordance with the appointment scheduling rules of the respective health care provider.

2. The health care appointment management system of claim 1, wherein the appointment scheduling data comprises open appointment slots of practitioners of the health care providers, booked appointment slots of the practitioners of the health care providers, or combinations thereof.

3. The health care appointment management system of claim 1, wherein the appointment scheduling rules of the one or more health care providers comprise practice business hours, practice staff hours, holidays period, vacation period of practitioners, provider hours, provider open slots per visit reason, specific availability by a visit reason, provider overbook limit per open slot, special slots like same day slots, same day and next day slots, calendar openings with multiple bookings, patient type, appointments and procedure time by type of ailment, or combinations thereof.

4. The health care appointment management system of claim 1, wherein the processing module is configured to determine available appointment slots for each of the one or more health care providers in real time by integrating the appointment scheduling data with appointment updates for the corresponding health care provider.

5. The health care appointment management system of claim 4, wherein the system further comprises a display module configured to display the available appointment slots for each of the one or more health care providers.

6. The health care appointment management system of claim 5, wherein the display module comprises a website, a mobile platform, managed by the health care appointment management system, or by a third party.

7. The health care appointment management system of claim 1, wherein the integration module is communicatively coupled to the one or more electronic practice management systems via a standard or proprietary communication interface.

8. The health care appointment management system of claim 1, wherein the communication interface is configured to transmit a message to the integration module upon an event of a new appointment, a cancellation of an existing appointment, a reschedule of an existing appointment, or combinations thereof.

9. The health care appointment management system of claim 1, wherein the system is configured to facilitate read and write integration with the EPMs of one or more health care providers using a baseline synchronization, a real-time synchronization, or combinations thereof.

10. The health care appointment management system of claim 9, wherein:
the integration module is configured to receive baseline appointment scheduling data from the EPMs on a periodic basis using provider login credentials; and
the processing module is configured to process the baseline appointment scheduling data and to determine availability of resources of the corresponding health care provider.

11. The health care appointment management system of claim 9, wherein:
the integration module is configured to receive real-time appointment scheduling data from the EPMs; and
the processing module is configured to utilize the real-time appointment scheduling data to update the availability of resources of the corresponding health care provider.

12. The health care appointment management system of claim 9, wherein the integration module is configured to send a message based on an event triggered related to new appointment, a cancellation of an existing appointment, a reschedule of an existing appointment in the health care appointment management system to the electronic practice management systems (EPMs) of one or more health care providers.

13. The health care appointment management system of claim 9, wherein the processing module is configured to send a message to a patient regarding updates of the availability of resources.

14. A computer implemented method for managing health care appointments, the method comprising:
receiving appointment scheduling data and appointment scheduling rules corresponding to the one or more health care providers;
storing the appointment scheduling data and the appointment scheduling rules corresponding to the one or more health care providers; and
processing the appointment scheduling data and managing appointment updates for each of the one or more health care providers in accordance with the appointment scheduling rules of the respective health care provider.

15. The method of claim 14, wherein processing the appointment scheduling data and managing appointment updates further comprises determining available appointment slots for each of the one or more health care providers in real time by integrating the appointment scheduling data with appointment updates for the corresponding health care provider.

16. The method of claim 14, further comprising
displaying the available appointment slots for each of the one or more health care providers;
transmitting a message to the electronic practice management systems (EPMs) of the corresponding health care provider based upon an event of a new appointment, a cancellation of an existing appointment, a reschedule of an existing appointment or combinations thereof.

17. The method of claim 14, further comprising facilitating read and write integration with one or more electronic practice management systems (EPMs) of one or more health care providers using a baseline synchronization, a real-time synchronization, or combinations thereof.

18. The method of claim 17, wherein:
receiving baseline appointment scheduling data from the EPMs on a periodic basis using provider login credentials; and
processing the baseline appointment scheduling data and determining availability of resources of the corresponding health care provider.

19. The method of claim 17, wherein:
receiving real-time appointment scheduling data from the EPMs;
utilizing the real-time appointment scheduling data for updating the availability of resources of the corresponding health care provider; and
sending a message to a patient regarding updates of the availability of resources.

20. A non-transitory computer readable medium having computer-executable instructions stored thereon that are executable by a processor to perform or cause to be performed the method of claim 14.
